(19) United States
(12) Patent Application Publication
(10) Pub. No.: US 2008/0311405 A1
(43) Pub. Date: Dec. 18, 2008

(54) Reinforcing Sheet

(76) Inventors: Wei Wang, Brick, NJ (US); Atsushi Kuriu, Aichi (JP)

Correspondence Address: SUGHRUE MION, PLLC, 2100 PENNSYLVANIA AVENUE, N.W., SUITE 800, WASHINGTON, DC, 20037, US

(21) Appl. No.: 11/794,866

(22) PCT Filed: Jan. 11, 2006
(86) PCT No.: PCT/US06/00723

§ 371 Date: Aug. 28, 2008

Related U.S. Application Data
(60) Provisional application No. 60/643,142, filed on Jan. 12, 2005.

(51) Int. Cl. B32B 27/38

(52) U.S. Cl. 428/417; 428/413; 428/418

(57) ABSTRACT

A reinforcing sheet, including a constraining layer and a reinforcing layer; a reinforced substrate, including the reinforcing sheet on a side of a substrate; and a method for reinforcing a substrate, including providing the reinforcing sheet on a side of the substrate. The reinforcing layer contains a foam composition containing (A) an epoxy resin, (B) an epoxy-modified rubber, and (C) a hydrophobic hydrocarbon oil. The reinforcing sheet may exhibit an improved resistance to water.

### CROSS-REFERENCE TO RELATED APPLICATION

This application claims the benefit of U.S. Provisional Application No. 60/643,142, filed Jan. 12, 2005.

### FIELD OF THE INVENTION

This invention relates to reinforcing sheets, such as, for example, reinforcing sheets for sheet metal, sheet plastic structures, or steel plates.

### BACKGROUND OF THE INVENTION

Reinforcing sheets have a wide variety of uses in industry. For example, sheet metal to be used in the shell of a transportation vehicle, such as, e.g., an automobile, may be thin, having a thickness of, e.g., from 0.6 mm to 0.8 mm, in order to minimize vehicle weight. Such thin sheets may be susceptible to stress deformation.

To combat stress deformation, manufacturers have been known to provide a reinforcing sheet on a side of the sheet metal, e.g., by adhesively bonding a reinforcing sheet on the inside of the sheet metal. As a particular example, a reinforcing sheet may be adhesively bonded and thermally foamed by using heat generated at the time of electrodeposition coating to develop the reinforcing property of the reinforcing sheet during the fabrication process of the sheet metal to be used for the shell of an automobile.

### SUMMARY OF THE INVENTION

In a first aspect, the invention features a reinforcing sheet. The reinforcing sheet includes a constraining layer and a reinforcing layer. The reinforcing layer contains a foam composition containing (A) an epoxy resin, (B) an epoxy-modified rubber, and (C) a hydrophobic hydrocarbon oil.

In a second aspect, the invention features a reinforced substrate. The reinforced substrate includes the reinforcing sheet of the first aspect on a side of a substrate.

In a third aspect, the invention features a method for reinforcing a substrate. The method includes providing the reinforcing sheet of the first aspect on a side of the substrate.

One or more of the following features may also be included. The reinforcing layer may contain each of the epoxy-modified rubber (B) and the hydrophobic hydrocarbon oil (C) in an amount of at least 1 wt %, based on the total weight of the reinforcing layer. The epoxy-modified rubber (B) may have an epoxy equivalent of from 100 to 1,000 g/eqiv. The reinforcing layer may further contain a curing agent and a blowing agent. The constraining layer may contain a glass fiber cloth, a resin-impregnated glass fiber cloth, a synthetic resin unwoven cloth, or a metal foil. The substrate may include sheet metal.

Embodiments may have one or more of the following advantages. The reinforcing sheets may exhibit an improved resistance to water. The reinforcing sheets may simultaneously demonstrate sufficient adhesion to a substrate and sufficient reinforcement of the substrate.

Further aspects, features, and advantages will become apparent by the following.

### DETAILED DESCRIPTION OF THE INVENTION

The reinforcing sheet includes a constraining layer and a reinforcing layer. The constraining layer and the reinforcing layer may be joined firmly and integrally together. For example, the constraining layer and the reinforcing layer may be laminated or adhesively bonded together. The constraining layer may provide tenacity or stiffness to the reinforcing layer, especially after the reinforcing layer has been foamed.

The constraining layer may be in the form of a sheet. The constraining layer may be formed of any suitable material, and especially any lightweight and thin-film material. For example, the constraining layer may contain a material such as, for example, a glass fiber cloth, a resin-impregnated glass fiber cloth, a synthetic resin unwoven cloth, a metal foil, or a carbon fiber.

Suitable glass fiber cloths are not particularly limited and may include, e.g., a cloth formed of glass fibers.

Suitable resin-impregnated glass fiber cloths are not particularly limited and may include, e.g., a glass fiber cloth impregnated with a synthetic resin, such as a thermosetting resin, a thermoplastic resin, or mixtures thereof. Suitable thermosetting resins are not particularly limited and may include, e.g., an epoxy resin, a urethane resin, a melamine resin, or a phenol resin. Suitable thermoplastic resins are not particularly limited and may include, e.g., a vinyl acetate resin, an ethylene-vinyl acetate copolymer (EVA), a vinyl chloride resin, or an EVA-vinyl chloride resin copolymer. Suitable mixtures of the thermosetting resin and the thermoplastic resin are not particularly limited and may include, e.g., the combination of a melamine resin and a vinyl acetate resin.

Suitable metal foils are not particularly limited and may include, e.g., an aluminum foil or a steel foil.

Preferred constraining layers may contain a glass fiber cloth or a resin-impregnated glass fiber cloth. Such constraining layers may be especially desirable for their weight, degree of adhesion, strength, and/or cost.

The reinforcing layer contains a foam composition containing (A) an epoxy resin, (B) an epoxy-modified rubber, and (C) a hydrophobic hydrocarbon oil. The reinforcing layer may be in the form of a sheet of the foam composition, and the foam composition may be foamed by heating.

Suitable epoxy resins for component (A) of the foam composition are not particularly limited. The epoxy resin may be a heat-cured synthetic resin having a terminal reactive epoxy group, and especially two or more reactive epoxy groups. The epoxy resin may be an aromatic epoxy resin, such as a bisphenol epoxy resin (e.g., bisphenol A type epoxy resin, dimer acid-modified bisphenol A type epoxy resin, bisphenol F type epoxy resin, bisphenol S type epoxy resin, etc.), a novolak-epoxy resin (e.g., phenol novolak epoxy resin, cresol novolak epoxy resin, etc.), a naphthalene epoxy resin, a cyclo-aliphatic epoxy resin, a ring-containing nitrogen epoxy resin, such as triglycidyl isocyanurate or hydantoin epoxy resin, a hydrogenated bisphenol A type epoxy resin, an aliphatic epoxy resin, a glycidyl ether epoxy resin, a biphenyl epoxy resin of a mainstream of low water absorption curing type, or a dicyclo ring type epoxy resin. An aromatic epoxy resin may be an epoxy resin containing a benzene ring as a molecular building unit in a molecular chain. A particular epoxy resin may be used alone or in combination with other epoxy resins.

Preferred foam compositions may contain an aromatic epoxy resin, and especially a bisphenol epoxy resin, as component (A). Such epoxy resins may be especially desirable as a component of the foam composition for their reinforcing capability.

Suitable epoxy-modified rubbers for component (B) of the foam composition are not particularly limited. An epoxy-modified rubber may be a rubber which has been modified with an epoxy group at an end of the molecular chain or in the molecular chain. The method for modifying the rubber with an epoxy group is not particularly limited. For example, an epoxidizing agent, such as a peracid or a hydroperoxide, may be allowed to react with a double bond in the rubber in an inert solvent.

The epoxy-modified rubber may be, for example, an epoxy-modified rubber wherein an epoxy group has been introduced in a B polymer block of an A-B type block copolymer or an A-B-A type block copolymer. For example, A may represent a styrene polymer block, and B may represent a conjugated diene polymer block, such as a butadiene polymer block or an isoprene polymer block. The epoxy-modified rubber may be, for example, an epoxy-modified styrene-butadiene-styrene block copolymer, an epoxy-modified styrene-ethylene-butadiene-styrene block copolymer, or an epoxy-modified styrene-isoprene-styrene block copolymer. A particular epoxy-modified rubber may be used alone or in combination with other epoxy-modified rubbers.

Preferred epoxy-modified rubbers may have an epoxy equivalent in the range of from 100-1,000 g/eqiv.

Preferred foam compositions may contain an epoxy-modified styrene synthetic rubber, and especially an epoxy-modified styrene-butadiene-styrene block copolymer, as component (B). Such epoxy-modified rubbers may be especially desirable as a component of the foam composition for their ability to promote the capability of the reinforcing sheet to simultaneously demonstrate sufficient adhesion to a substrate and sufficient reinforcement of the substrate.

Suitable hydrophobic hydrocarbon oils for component (C) of the foam composition are not particularly limited. The hydrophobic hydrocarbon oil may be a hydrophobic liquid rubber. For example, the hydrophobic hydrocarbon oil may be a polybutene.

Preferred foam compositions may contain a hydrophobic hydrocarbon oil having a viscosity of 10,000 cSt or less at 100° C. as component (C). Such hydrophobic hydrocarbon oils may be especially desirable as a component of the foam composition for their ability to promote the absorption of oil.

For example, sheet metal to be used in the shell of a transportation vehicle, such as, e.g., an automobile may include a small amount of oil thereon as a rust inhibitor. It may be difficult in certain embodiments for a foam composition containing a hydrophobic hydrocarbon oil having a viscosity of greater than 10,000 cSt at 100° C. to absorb oil from the sheet metal, which may lead to reduced adhesion between the reinforcing sheet and the sheet metal.

The foam composition may contain other components besides epoxy resin (A), epoxy-modified rubber (B), and hydrophobic hydrocarbon oil (C). The full range of additional components which may be included in the foam composition is not particularly limited. A few examples are set forth below.

The foam composition may contain a crosslinking agent. Suitable crosslinking agents which may be included in the foam composition are not particularly limited. For example, the crosslinking agent may be sulfur, a sulfur compound, selenium, magnesium oxide, lead monoxide, an organic peroxide (e.g., dicumyl peroxide, 1,1-ditert-butyl-peroxy-3,3-5-trimethylcyclohexane, 2,5-dimethyl-2,5-ditert-butyl-peroxyhexane, 2,5-dimethyl-2,5-ditert-buty-1-peroxyhexyne, 1,3-bis(tert-butyl-peroxy-isopropyl)benzene, tert-butyl-peroxy-ketone, and tert-butyl-peroxy-benzoate), a polyamine, an oxime (e.g., p-quinone dioxime and p,p′-dibenzoyl quinone dioxime, etc.), a nitroso compound (e.g., p-dinitroso benzene, etc.), a resin (e.g., alkyl phenol-formaldehyde resin, melamine-formaldehyde condensate), or an ammonium salt (e.g., ammonium benzoate, etc.). A particular crosslinking agent may be used alone or in combination with other crosslinking agents.

Preferred foam compositions may contain sulfur as a crosslinking agent. A sulfur crosslinking agent may be especially desirable for its strong crosslinking property and its reinforcing capability.

The foam composition may contain a curing agent, and especially epoxy resin curing agents. Suitable curing agents which may be included in the foam composition are not particularly limited. For example, the curing agent may be an isocyanate compound, an amine compound (e.g., ethylenediamine, propylenediamine, diethylenetriamine, triethylenetetramine, amine adducts thereof, metaphenylenediamine, diaminodiphenylmethane, and diaminodiphenylsulfone), an acid anhydride compound (e.g., phthalic anhydride, maleic anhydride, tetrahydrophthalic anhydride, hexahydrophthalic anhydride, methyl nadic anhydride, pyromelletic anhydride, dodecenylsuccinic anhydride, dichlorosuccinic anhydride, benzophenonetetracarboxylic anhydride, and chlorendic anhydride), an amide compound (e.g., dicyandiamide and polyamide), a hydrazide compound (e.g., dihydrazide), an imidazole compound (e.g., methyl imidazole, 2-ethyl-4-methyl imidazole, ethyl imidazole, isopropyl imidazole, 2,4-dimethylimidazole, phenylimidazole, undecylimidazole, heptadecylimidazole, and 2-phenyl-4-methylimidazole), an imidazoline compound (e.g., methylimidazoline, 2-ethyl-4-methylimidazoline, ethylimidazoline, isopropylimidazoline, 2,4-dimethylimidazoline, phenylimidazoline, undecylimidazoline, heptadecylimidazoline, and 2-phenyl-4-methyl imidazoline), a phenol compound, a urea compound, or a polysulfide compound. A particular curing agent may be used alone or in combination with other curing agents.

Preferred foam compositions may contain dicyandiamide as a curing agent. Such a curing agent may be especially desirable for their strong ability to promote adhesiveness.

The foam composition may contain a blowing agent. Suitable blowing agents are not particularly limited and may include, e.g., an inorganic blowing agent and/or an organic blowing agent. A particular blowing agent may be used alone or in combination with other blowing agents. In addition, a blowing agent may be used together with a blowing co-agent, such as, e.g., zinc stearate, a urea compound, a salicyclic compound, and a benzoic compound.

Suitable inorganic foaming agents may include, e.g., ammonium carbonate, ammonium hydrogen carbonate, sodium hydroxide, sodium hydroammonium, sodium hydrogen carbonate, ammonium nitrite, sodium borohydride, and azides.

Suitable organic foaming agents may include, e.g., an N-nitroso compound (e.g., N,N′-dinitrosopentamethylenetetramine, N,N′-dimethyl-N,N′-dinitrosoterephthalamide, etc.), an azoic compound (e.g., azobis(isobutyronitrile), azodicarboxylic amide, barium azodicarboxylate, azodicarbonamide, etc.), an alkane fluoride (e.g., trichloromonofluoromethane-, dichloromonofluoromethane, etc.), a hydrazine compound (e.g., paratoluene sulfonyl hydrazide, diphenylsulfone-3,3′-disulfonyl hydrazide, 4,4′-oxybis(benzene sulfonyl hydrazide), allylbis(sulfonyl hydrazide), etc.), a semicarbazide compound (e.g., p-toluoylenesulfonyl semicarbazide, 4,4′-oxybis(benzene sulfonyl semicarbazide, etc.), and a triazole compound (e.g., 5-morphoryl-1,2,3,4-thiatriazole, etc.).

Preferred foam compositions may contain 4,4′-oxybis(benzene sulfonyl hydrazide) as a blowing agent. Such blowing agents may be especially desirable for their lack of susceptibility to external factors and foaming stability.

The foam composition may contain a crosslinking accelerator. Suitable crosslinking accelerators which may be included in the foam composition are not particularly limited. For example, the crosslinking accelerator may be a zinc oxide, a dithiocarbamic acid, a thiazole, a guanidine, a sulfenamide, a thiuram, a xanthogenic acid, an aldehyde ammonia, an aldehyde amine, or a thiourea. A particular crosslinking accelerator may be used alone or in combination with other crosslinking accelerators.

The foam composition may contain a filler. Suitable fillers which may be included in the foam composition are not particularly limited. For example, the filler may be a calcium carbonate (e.g., calcium carbonate heavy, calcium carbonate light, and colloidal calcium carbonate, etc.), talc, mica, clay, mica powder, bentonite, silica, alumina, an aluminum silicate, a titanium oxide, acetylene black, barium sulfate, magnesium hydroxide, carbon black, glass fiber, a Theological additive, or an aluminum powder. A particular filler may be used alone or in combination with other fillers.

In addition to those mentioned above, additional classes of materials from which components of the foam composition may be selected include, but are not limited to, pigments (e.g., carbon black, etc.), thixotropic agents (e.g., montmorillonite, etc.), lubricants (e.g., stearic acid, etc.), antiscorching agents, stabilization agents, softening agents (e.g., process oil, extender oil, etc.), plasticizers, antiaging agents, antioxidants, ultraviolet absorbers, coloring agents, mildewproofing agents, and fire retardants.

Methods of preparing the foam composition and the reinforcing sheet as a whole are not particularly limited. For example, the foam composition may be prepared in the form of a kneaded material by mixing and kneading epoxy resin (A), epoxy-modified rubber (B), and hydrophobic hydrocarbon oil (C) with any one or more of the additional components mentioned above by using, for example, a banbury mixer, a planetary mixer, an open kneader, a sigma blade mixer, a mixing roll, a pressure kneader, or an extruder. Thereafter, the kneaded material may be rolled, for example, by calendaring, extrusion or press molding at a temperature at which components of the foam composition, such as the blowing agent, if any, may not be substantially decomposed, to form the reinforcing layer. Then, the reinforcing layer may be adhesively bonded to the constraining layer.

The reinforcing sheet thus obtained may then be joined to any of a variety of substrates, such as, e.g., sheet metal to be used in a transportation vehicle, to provide reinforcement thereto. For example, a reinforcing sheet may be formed by laminating a reinforcing layer on a constraining layer. If desired, an exfoliate paper may be applied on an outer surface of the reinforcing layer (the exfoliate paper later may be stripped from the surface of the reinforcing layer prior to use). Then, the surface of the reinforcing layer may be adhesively bonded to the sheet metal. Thereafter, the resulting lamination may be heated at a prescribed temperature (e.g., 160-210° C.) to foam, to crosslink, and to cure the reinforcing layer, to thereby form a reinforcing sheet containing a foamed reinforcing layer.

End-uses for the reinforcing sheets are not particularly limited. For example, the reinforcing sheets may be used to reinforce sheet metal to be used in the shell of an automobile. In such embodiments, the reinforcing sheet may be, for example, adhesively bonded to the sheet metal, first, in an assembling process of the sheet metal of the shell of the automobile. Then, the reinforcing sheet adhesively bonded to the sheet metal may be thermally foamed, cross-linked and cured by using the heat generated by electrodeposition coating, to thereby form a reinforcing sheet containing a foamed reinforcing layer.

The reinforcing sheets may exhibit an improved resistance to water. This may be especially useful for embodiments in which the reinforcing sheet is to be used to reinforce sheet metal to be used in the shell of an automobile. Whether from exposure to the elements or from manufacturing conditions, reinforced sheets used in the shell of an automobile are likely to encounter at least some water. A reinforcing sheet with a poor resistance to water may gradually lose its reinforcing ability. In contrast, reinforcing sheets including a constraining layer and a reinforcing layer, wherein the reinforcing layer contains a foam composition containing (A) an epoxy resin, (B) an epoxy-modified rubber, and (C) a hydrophobic hydrocarbon oil, are better able to sufficiently maintain their reinforcing property in the face of water exposure.

Furthermore, the reinforcing sheet may simultaneously demonstrate sufficient adhesion to a substrate and sufficient reinforcement of the substrate.

### EXAMPLES

The following specific examples further illustrate the invention.

### A) Example and Comparative Example Formulations

Foam compositions having the formulations shown in Tables 1-4 (parts by weight) below were prepared by mixing and kneading the components for 5 minutes using a 3 L sigma blade mixer at 75° C. Then, using a heat press machine, a reinforcing layer in the form of a 1.0 mm thick sheet was obtained. The obtained reinforcing layer sheet was laminated to a constraining layer containing glass fiber cloth and having a thickness of 0.2 mm. The glass fiber cloth had previously undergone sizing treatment with a melamine resin (glass cloth weight=220 g/m²; sizing agent amount=20 g/m²). A release liner was laminated to a side of the reinforcing layer opposite the constraining layer, thereby obtaining a three-layer reinforcing sheet including the constraining layer, the reinforcing layer, and the release liner, in that order.

TABLE 1

| No. | Raw Material | Example 1 | Comp. Ex. 1 | Comp. Ex. 2 |
|---|---|---|---|---|
| 1 | Bisphenol A epoxy | 4.6 | 4.6 | 4.6 |
| | resin (solid) | | | |
| 2 | Talc | 55.6 | 55.6 | 55.6 |
| 3 | Cyanoguanidine | 4.6 | 4.6 | 4.6 |
| 4 | Bisphenol A epoxy | 16 | — | 16 |
| | resin-modified rubber | | | |
| | (HypoxRA95) | | | |
| 5 | Glass fiber | 23.2 | 23.2 | 23.2 |
| 6 | Organo | 8.3 | 8.3 | 8.3 |
| | montmorillonite | | | |
| 7 | Phenyl dimethyl urea | 0.5 | 0.5 | 0.5 |
| 8 | Carbon black | 0.3 | 0.3 | 0.3 |
| 9 | Bisphenol A epoxy | 64 | 80 | 64 |
| | resin (liquid) | | | |
| 10 | Hydrophobic | 9 | 9 | — |
| | hydrocarbon oil | | | |
| | (polybutene) | | | |
| 11 | Blowing agent | 1.5 | 1.5 | 1.5 |
| 12 | Blowing co-agent | 1 | 1 | 1 |

In Table 1 above, the foam composition of Example 1 and each of the foam compositions of Comparative Examples 1 and 2 have the same formulations, except that (i) the foam composition of Comparative Example 1 does not contain bisphenol A epoxy resin-modified rubber (HypoxRA95) and contains 80 ppw of Bisphenol A epoxy resin liquid (in comparison to 64 ppw of Bisphenol A epoxy resin liquid in Example 1 and Comparative Example 2) and (ii) the foam composition of Comparative Example 2 does not contain hydrophobic hydrocarbon oil (polybutene). Bisphenol A epoxy resin-modified rubber (HypoxRA95) contains nitrile-butadiene rubber as a base rubber and has a nitrile monomer content of 27 wt %.

TABLE 2

| No. | Raw Material | Example 2 | Comp. Ex. 3 |
|---|---|---|---|
| 1 | Bisphenol A epoxy resin (solid) | 4.6 | 4.6 |
| 2 | Talc | 55.6 | 55.6 |
| 3 | Cyanoguanidine | 4.6 | 4.6 |
| 4 | Bisphenol A epoxy resin- | 16 | 16 |
| | modified rubber | | |
| | (HypoxRA1340) | | |
| 5 | Glass fiber | 23.2 | 23.2 |
| 6 | Organo montmorillonite | 8.3 | 8.3 |
| 7 | Phenyl dimethyl urea | 0.5 | 0.5 |
| 8 | Carbon black | 0.3 | 0.3 |
| 9 | Bisphenol A epoxy resin | 64 | 64 |
| | (liquid) | | |
| 10 | Hydrophobic hydrocarbon oil | 9 | — |
| | (polybutene) | | |
| 11 | Blowing agent | 1.5 | 1.5 |
| 12 | Blowing co-agent | 1 | 1 |

In Table 2 above, the foam compositions of Example 2 and Comparative Example 3 are the same as the foam compositions of Example 1 and Comparative Example 2, respectively, except that the bisphenol A epoxy resin-modified rubber is HypoxRA1340 rather than HypoxRA95. HypoxRA1340 and HypoxRA95 are grades of commercially available bisphenol A epoxy resin-modified rubber having different properties, as summarized in Table 2-1 below.

TABLE 2-1

| | HyPoxRA95 | HyPoxRA1340 |
|---|---|---|
| Viscosity at (cps) | 15,000-30,000 | 300,000-600,000 |
| | (at 52° C.) | (at 25° C.) |
| Epoxide equivalent | 195-206 | 325-375 |
| weight (g/eq) | | |

In Table 3 below, each of the foam compositions of Examples 3-5 is the same as the foam composition of Example 1, except that the amount of bisphenol A epoxy resin-modified rubber (HypoxRA95) is 1.1 wt % in Example 3, 5.2wt % in Example 4, and 20.5 wt % in Example 5, in comparison to 8.5wt % in Example 1.

TABLE 3

| No. | Raw Material | Example 3 | Example 4 | Example 5 |
|---|---|---|---|---|
| 1 | Bisphenol A epoxy | 4.6 | 4.6 | 4.6 |
| | resin (solid) | | | |
| 2 | Talc | 55.6 | 55.6 | 55.6 |
| 3 | Cyanoguanidine | 4.6 | 4.6 | 4.6 |
| 4 | Bisphenol A epoxy | 1.8 | 9.4 | 44.4 |
| | resin-modified rubber | | | |
| | (HypoxRA95) | | | |
| 5 | Glass fiber | 23.2 | 23.2 | 23.2 |
| 6 | Organo | 8.3 | 8.3 | 8.3 |
| | montmorillonite | | | |
| 7 | Phenyl dimethyl urea | 0.5 | 0.5 | 0.5 |
| 8 | Carbon black | 0.3 | 0.3 | 0.3 |
| 9 | Bisphenol A epoxy | 64 | 64 | 64 |
| | resin (liquid) | | | |
| 10 | Hydrophobic | 9 | 9 | 9 |
| | hydrocarbon oil | | | |
| | (polybutene) | | | |
| 11 | Blowing agent | 1.5 | 1.5 | 1.5 |
| 12 | Blowing co-agent | 1 | 1 | 1 |

In Table 4 below, each of the foam compositions of Examples 6-8 is the same as the foam composition of Example 3, except that the amount of hydrophobic hydrocarbon oil (polybutene) is 1.2 wt % in Example 6, 9.7 wt % in Example 7, and 17.7 wt % in Example 8, in comparison to 4.8 wt % in Example 3.

TABLE 4

| No. | Raw Material | Example 6 | Example 7 | Example 8 |
|---|---|---|---|---|
| 1 | Bisphenol A epoxy | 4.6 | 4.6 | 4.6 |
| | resin (solid) | | | |
| 2 | Talc | 55.6 | 55.6 | 55.6 |
| 3 | Cyanoguanidine | 4.6 | 4.6 | 4.6 |
| 4 | Bisphenol A epoxy | 1.8 | 1.8 | 1.8 |
| | resin-modified rubber | | | |
| | (HypoxRA95) | | | |
| 5 | Glass fiber | 23.2 | 23.2 | 23.2 |
| 6 | Organo | 8.3 | 8.3 | 8.3 |
| | montmorillonite | | | |
| 7 | Phenyl dimethyl urea | 0.5 | 0.5 | 0.5 |
| 8 | Carbon black | 0.3 | 0.3 | 0.3 |
| 9 | Bisphenol A epoxy | 64 | 64 | 64 |
| | resin (liquid) | | | |
| 10 | Hydrophobic | 2 | 18 | 33 |
| | hydrocarbon oil | | | |
| | (polybutene) | | | |
| 11 | Blowing agent | 1.5 | 1.5 | 1.5 |
| 12 | Blowing co-agent | 1 | 1 | 1 |

In Tables 1-4 above, each of the indicated raw materials is commercially available from the following manufacturers:

No. 1: Bisphenol A epoxy resin (solid)
Product Name: EPALLOY 7192
Supplier: CVC Specialty Chemicals Inc.

No. 2: Talc
Product Name: NICRON 353
Supplier: Van Horn Metz & Co. Inc.

No. 3: Cyanogianidine
Product Name: AMICURE CG325
Supplier: Eastech Chemical

No. 4: Bisphenol A epoxy resin-modified rubber
Product Name HyPox RA95 or HyPox RA1340
Supplier: CVC Specialty Chemicals Inc.

No. 5: Glass fiber
Product Name: 731 EC
Supplier: Ashland

No. 6: Organo montmorillonite
Product Name Claytone HT
Supplier: D. H. Litter

No. 7: Phenyl dimethyl urea
Product Name: OMICURE U405
Supplier: CVC Specialty Chemicals Inc.

No. 8: Carbonblack
Product Name Arosperse 11
Supplier: Tokyo Zairyo

No. 9: Bisphenol A epoxy resin (liquid)
Product Name HyPox DA323
Supplier: CVC Specialty Chemicals Inc.

No. 10: Hydrophobic hydrocarbon oil (polybutene)
Product Name Poly SH1900
Supplier Name: S & S Chemicals
Density=7.6 lb/gal; Viscosity=4,200-4,600 cSt at 100° C.

No. 11: Blowing agent (azo-di-carbonamide)
Product Name Celogen AZ130
Supplier Name Crompton Co.

No. 12: Blowing co-agent (urea)
Product Name: BYK-OT
Supplier Name Chemrep Co.

### B) Evaluation

The water resistance of each of the reinforcing sheets of the Examples and Comparative Examples was evaluated in terms of the sheet's ability to retain its peak reinforcing effect after immersion in water.

Specifically, after first removing its release liner, a reinforcing sheet was adhesively bonded to an oiled, cold-rolled steel plate (SPCC-SD, available from Nippon Testpanel Co., Ltd.), which was 25 mm wide, 150 mm long, and 0.8 mm thick, under an atmosphere of 20° C. Then, the reinforcing sheet adhesively bonded to the steel plate was heated at 180° C. for 30 minutes, whereby the reinforcing layer was foamed and cured. Test pieces were obtained in this manner, wherein the same operation was carried out for each Example and Comparative Example.

Thereafter, each test piece was supported by a pair of bars forming support points having a span of 100 mm, wherein the steel plate side of the test piece was facing up and the constraining layer side of the test piece was facing down. A test bar was then moved down in a vertical direction from above on a lengthwise center portion of the test piece at a rate of compression of 5 mm/min. The test bar was pressed down against the steel plate side of the test piece until the foamed reinforcing layer ruptured. The force needed to rupture the foamed reinforcing layer was measured as the reinforcing effect (N).

The reinforcing effect for each test piece was measured three times according to the following test procedure A and three times according to the following test procedure B. For Test A, after the reinforcing layer was foamed and cured in the manner indicated above, the test piece was allowed to cool down to room temperature, whereafter the reinforcing effect (N) was measured in the manner indicated above. For Test B, after the reinforcing layer was foamed and cured in the manner indicated above, and the test piece was allowed to cool down to room temperature, the test piece was immersed in water having a temperature of 38° C. for 168 hours. Thereafter, the test piece was allowed to dry at room temperature for 24 hours, and the reinforcing effect (N) was measured in the manner indicated above.

For each Example and Comparative Example, the averages of the three iterations for Tests A and B were used to calculate the retained percentage of peak strength using the following equation:

Retained percentage of peak strength(%)=(Test B avg./Test A avg.)×100

The higher the retained percentage of peak strength, the better the water resistance. The results are shown in Tables 5-8 below, wherein the numerical unit is N.

TABLE 5

| Reinforcement | | | |
|---|---|---|---|
| property | Example 1 | Comp. Ex. 1 | Comp. Ex. 2 |
| Test A | \textcircled{1} 14.0 | \textcircled{1} 13.6 | \textcircled{1} 18.3 |
| | \textcircled{2} 16.2 | \textcircled{2} 11.4 | \textcircled{2} 17.8 |
| | \textcircled{3} 18.4 | \textcircled{3} 12.3 | \textcircled{3} 19.1 |
| | Avg: 16.2 | Avg: 12.4 | Avg: 18.4 |
| Test B | \textcircled{1} 12.7 | \textcircled{1} 4.4 | \textcircled{1} 13.2 |
| | \textcircled{2} 12.5 | \textcircled{2} 4.5 | \textcircled{2} 11.3 |
| | \textcircled{3} 13.5 | \textcircled{3} 4.3 | \textcircled{3} 12.4 |
| | Avg: 12.9 | Avg: 4.4 | Avg: 12.3 |
| Retained | 80 | 35 | 67 |
| percentage of peak | | | |
| strength (%) | | | |

The results from Table 5 above indicate that adding an epoxy-modified rubber to a foam composition containing both an epoxy resin and a hydrophobic hydrocarbon oil improves the water resistance of a reinforcing sheet which includes a foamed reinforcing layer formed from the foam composition. Without being bound to any theory, it is believed that the epoxy-modified rubber functions as a compatibility agent for the epoxy resin and the hydrophobic hydrocarbon oil. Consequently, the dispersion of the hydrophobic hydrocarbon oil in the foam composition is promoted by the presence of the epoxy-modified rubber, which in turn promotes improved water resistance.

TABLE 6

| Reinforcement property | Example 2 | Comp. Ex. 3 |
|---|---|---|
| Test A | \textcircled{1} 16.3 | \textcircled{1} 18.8 |
| | \textcircled{2} 15.1 | \textcircled{2} 19.4 |
| | \textcircled{3} 15.7 | \textcircled{3} 20.0 |
| | Avg: 15.7 | Avg: 19.4 |
| Test B | \textcircled{1} 13.5 | \textcircled{1} 15.1 |
| | \textcircled{2} 13.9 | \textcircled{2} 15.3 |
| | \textcircled{3} 13.7 | \textcircled{3} 14.8 |
| | Avg: 13.7 | Avg: 15.1 |
| Retained percentage of | 87 | 78 |
| peak strength (%) | | |

The results from Table 6 above confirm that adding an epoxy-modified rubber to a foam composition containing both an epoxy resin and a hydrophobic hydrocarbon oil improves the water resistance of a reinforcing sheet which includes a foamed reinforcing layer formed from the foam composition.

TABLE 7

| Reinforcement | | | |
|---|---|---|---|
| property | Example 3 | Example 4 | Example 5 |
| Test A | \textcircled{1} 15.0 | \textcircled{1} 14.9 | \textcircled{1} 17.9 |
| | \textcircled{2} 15.5 | \textcircled{2} 14.3 | \textcircled{2} 18.2 |
| | \textcircled{3} 15.9 | \textcircled{3} 16.8 | \textcircled{3} 18.6 |
| | Avg: 15.5 | Avg: 15.3 | Avg: 18.2 |
| Test B | \textcircled{1} 13.4 | \textcircled{1} 13.3 | \textcircled{1} 20.8 |
| | \textcircled{2} 13.4 | \textcircled{2} 14.1 | \textcircled{2} 20.8 |
| | \textcircled{3} 12.9 | \textcircled{3} 13.4 | \textcircled{3} 20.0 |
| | Avg: 13.2 | Avg: 13.6 | Avg: 20.5 |
| Retained | 86 | 89 | 113 |
| percentage of peak | | | |
| strength (%) | | | |

The results from Table 7 above confirm that adding even as low as 1 wt % of an epoxy-modified rubber to a foam composition containing both an epoxy resin and a hydrophobic hydrocarbon oil improves the water resistance of a reinforcing sheet which includes a foamed reinforcing layer formed from the foam composition.

TABLE 8

| Reinforcement | | | |
|---|---|---|---|
| property | Example 6 | Example 7 | Example 8 |
| Test A | \textcircled{1} 17.3 | \textcircled{1} 17.1 | \textcircled{1} 14.5 |
| | \textcircled{2} 15.4 | \textcircled{2} 15.5 | \textcircled{2} 14.5 |
| | \textcircled{3} 18.8 | \textcircled{3} 16.0 | \textcircled{3} 15.3 |
| | Avg: 17.2 | Avg: 16.2 | Avg: 14.8 |
| Test B | \textcircled{1} 16.6 | \textcircled{1} 14.9 | \textcircled{1} 13.3 |
| | \textcircled{2} 15.0 | \textcircled{2} 15.7 | \textcircled{2} 13.9 |
| | \textcircled{3} 15.4 | \textcircled{3} 16.2 | \textcircled{3} 12.8 |
| | Avg: 15.7 | Avg: 15.6 | Avg: 13.3 |
| Retained | 91 | 96 | 90 |
| percentage of peak | | | |
| strength (%) | | | |

The results from Table 8 above confirm that adding as low as 1 wt % of an epoxy-modified rubber to a foam composition containing an epoxy resin and as low as 1 wt % of a hydrophobic hydrocarbon oil improves the water resistance of a reinforcing sheet which includes a foamed reinforcing layer formed from the foam composition.

Other embodiments are within the following claims.

What is claimed is:

1. A reinforcing sheet, comprising a constraining layer and a reinforcing layer, wherein the reinforcing layer comprises a foam composition comprising (A) an epoxy resin, (B) an epoxy-modified rubber, and (C) a hydrophobic hydrocarbon oil.

2. The reinforcing sheet of claim 1, wherein the reinforcing layer comprises each of the epoxy-modified rubber (B) and the hydrophobic hydrocarbon oil (C) in an amount of at least 1 wt %, based on the total weight of the reinforcing layer.

3. The reinforcing sheet of claim 1, wherein the epoxy-modified rubber (B) has an epoxy equivalent of from 100 to 1,000 g/eqiv.

4. The reinforcing sheet of claim 1, wherein the reinforcing layer further comprises a curing agent and a blowing agent.

5. The reinforcing sheet of claim 1, wherein the constraining layer comprises a material selected from the group consisting of a glass fiber cloth, a resin-impregnated glass fiber cloth, a synthetic resin unwoven cloth, and a metal foil.

6. A reinforced substrate, comprising a reinforcing sheet on a side of a substrate, wherein the reinforcing sheet comprises a constraining layer and a reinforcing layer, and wherein the reinforcing layer comprises a foam composition comprising (A) an epoxy resin, (B) an epoxy-modified rubber, and (C) a hydrophobic hydrocarbon oil.

7. The reinforced substrate of claim 6, wherein the substrate comprises sheet metal.

8. The reinforced substrate of claim 6, wherein the reinforcing layer comprises each of the epoxy-modified rubber (B) and the hydrophobic hydrocarbon oil (C) in an amount of at least 1 wt %, based on the total weight of the reinforcing layer.

9. The reinforced substrate of claim 6, wherein the epoxy-modified rubber (B) has an epoxy equivalent of from 100 to 1,000 g/eqiv.

10. The reinforced substrate of claim 6, wherein the reinforcing layer further comprises a curing agent and a blowing agent.

11. The reinforced substrate of claim 6, wherein the constraining layer comprises a material selected from the group consisting of a glass fiber cloth, a resin-impregnated glass fiber cloth, a synthetic resin unwoven cloth, and a metal foil.

12. A method for reinforcing a substrate, comprising providing a reinforcing sheet on a side of the substrate, wherein the reinforcing sheet comprises a constraining layer and a reinforcing layer, and wherein the reinforcing layer comprises a foam composition comprising (A) an epoxy resin, (B) an epoxy-modified rubber, and (C) a hydrophobic hydrocarbon oil.

13. The method of claim 12, wherein the substrate comprises sheet metal.

14. The method of claim 12, wherein the reinforcing layer comprises each of the epoxy-modified rubber (B) and the hydrophobic hydrocarbon oil (C) in an amount of at least 1 wt %, based on the total weight of the reinforcing layer.

15. The method of claim 12, wherein the epoxy-modified rubber (B) has an epoxy equivalent of from 100 to 1,000 g/eqiv.

16. The method of claim 12, wherein the reinforcing layer further comprises a curing agent and a blowing agent.

17. The method of claim 12, wherein the constraining layer comprises a material selected from the group consisting of a glass fiber cloth, a resin-impregnated glass fiber cloth, a synthetic resin unwoven cloth, and a metal foil.
